(19) United States
(12) Patent Application Publication
(10) Pub. No.: US 2006/0255670 A1
(43) Pub. Date: Nov. 16, 2006

(54) Eccentric rotor and vibration motor having the rotor

(76) Inventors: Hyun-Seung Ki, Suwon-si (KR); Myung-Chae Joung, Suwon-si (KR); Myung-Sam Kang, Seo-gu (KR); Jae-Kul Lee, Seoul (KR); Du-Ki Kim, Suwon-si (KR); Duck-Shik Kim, Anyang-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/240,150

(22) Filed: Sep. 29, 2005

(30) Foreign Application Priority Data
May 16, 2005 (KR) 10-2005-0040612

(51) Int. Cl. H02K 7/06; H02K 7/10

(52) U.S. Cl. 310/81

(57) ABSTRACT

An eccentric rotor and a vibration motor having the rotor are disclosed. In one embodiment, the eccentric rotor comprises: a board with an insertion hole, patterned coil layers on the upper portion of the board having multiple patterned coils and stacked in several layers, and commutators formed on the lower portion of the board electrically connected to the patterned coils and formed in integer multiples of the patterned coils, wherein the board is eccentric with regards to the insertion hole. In one embodiment, the eccentric rotor and vibration motor having the rotor can significantly increase the amount of vibration even with a small volume, as well as reduce manufacture time and costs.

### BACKGROUND OF THE INVENTION

1. Field of the Invention

The present invention relates to an eccentric rotor and a vibration motor having the eccentric rotor, and in particular, an eccentric rotor and a vibration motor including patterned coils.

2. Description of the Related Technology

A vibration motor that has an eccentric rotor is currently widely used in mobile phones and PDAs, etc., as a means of creating vibration upon receipt of incoming calls. As telecommunication devices decrease in size, the demand for smaller and thinner vibration motors is also increasing.

FIG. 1 is a sectional view illustrating the structure of a conventional vibration motor. The conventional vibration motor has a bracket 1 at the bottom. An end of a shaft 9 is inserted and fixed to the center of the bracket 1, and the other end of the shaft 9 is fixed by a case 8. The case 8 protects the other parts of the vibration motor from external interferences. A thin flexible board 12 is placed on the top of the bracket 1.

A multi-polar magnet 2 with alternating N, S poles is placed on the perimeter of the central flexible board 12 In the central cavity of the magnet 2, a pair of brushes 3 (only one brush shown in FIG. 1) are positioned at a designated angle with the lower ends attached to the flexible board 12. A bearing 11 is inserted into a designated position of the shaft 9. An eccentric rotor 10 is inserted along the perimeter of the bearing 11. A plurality of commutators 7 (see FIG. 2b) that are in contact with the brushes 3 are positioned on the bottom of the rotor 10.

FIG. 2a is a perspective view illustrating the upper portion of the conventional eccentric rotor 10.

As shown in FIG. 2a, the rotor 10 is positioned on a board 4 that is cut from a flat circular plate. A plurality of wound coils 5 arranged at designated angles are positioned on the upper portion of the board 4. Also, a weight 13 that increases the eccentricity of the rotor 10 is located on the board 4 between the wound coils 5. The wound coils 5 and weight 13 are fixed to the board 4 by, for example, a molded form 6 made of a material such as plastic, etc.

FIG. 2b is a perspective view illustrating the bottom of the conventional eccentric rotor 10. As shown in FIG. 2b, the commutators 7 of a flat plate shape are arranged radially around the rotation axis of the rotor 10 on the bottom of the board 4.

In such a vibration motor, as the current from an external source is provided through the flexible board 12 and brushes 3 to the wound coils 5, the rotor 10 is rotated by the electromagnetic interaction between the wound coils 5 and magnet 2. The rotor 10 is operated eccentrically, as it is eccentrically supported by the shaft 9 of which both ends are fixed by the bracket 1 and case 8, respectively. This eccentric driving power is transferred via the shaft 9 to the bracket 1, resulting in vibration.

Therefore, it can be seen that the vibration effect of the vibration motor occurs due to the eccentricity of the rotor 10 from the disproportionate concentration of mass caused by the weight 13. Consequently, it is required to increase the eccentricity of the rotor 10 to produce a greater vibration.

As illustrated above, the wound coils 5 are used in the rotor 10, but the wound coils 5 require increased manufacture time and costs. In addition, the wound coils 5 are substantial in volume, causing an increase in the volumes of the rotor 10 and thus the vibration motor. Furthermore, the coils 5 are generally very thin, about 45˜55 μm, so that the coils 5 often snap during the production process, thus causing the loss of useable rotors due to the defect.

Also, as the wound coils 5 must be accurately attached at constant intervals from the center of the board 4, the accurate positioning and attaching of the wound coils 5 cause the problems of increased manufacture time and cost.

In addition, the weight 13 is formed on the board 4 within a limited space, but since the weight 13 is positioned together with the wound coils 5, there is difficulty in increasing the size of the weight 13. In particular, when the size of the weight 13 is increased so as to provide a greater eccentricity of the rotor 10, the size of the wound coils 5 is decreased, causing a reduction in the performance of the rotor 10. Thus, given a rotor size, there is a limit as to how eccentric the rotor 10 can be made.

### SUMMARY OF CERTAIN INVENTIVE ASPECTS

One aspect of the present invention provides an eccentric rotor and a vibration motor having the eccentric rotor which improve vibration performance. Another aspect of the invention provides an eccentric rotor and a vibration motor having the eccentric rotor that reduce manufacture time and cost.

Another aspect of the invention provides an eccentric rotor comprising: a board with an insertion hole, patterned coil layers formed on the upper portion of the board, having multiple patterned coils and stacked in several layers, and commutators formed on the lower portion of the board, which are electrically connected to the patterned coils and are formed in integer multiples of the patterned coils, wherein the board is eccentric with regards to the insertion hole.

In one embodiment, since the eccentric rotor utilizes several layers of patterned coils instead of wound coils, it is possible to decrease the size of the eccentric rotor and to increase the amount of vibration, as well as to reduce production time and cost.

In one embodiment, the eccentric rotor can further increase the amount of vibration by including a weight formed on the patterned coil layer and an attachment member that fixes the weight to the patterned coil layer.

Another aspect of the invention provides an eccentric rotor comprising: a circular board with an insertion hole, patterned coil layers formed on the upper portion of the board, having multiple patterned coils and stacked in several layers, commutators formed on the lower portion of the board, which are electrically connected to the patterned coils and are formed in integer multiples of the patterned coils, a weight formed on the patterned coil layers, and an attachment member which fixes the weight to the patterned coil layers.

In one embodiment, the patterned coil layers are stacked successively on both sides of the base, with insulation layers in-between the patterned coil layers.

In one embodiment, the patterned coils are radially arranged at constant intervals on the board, and six or more layers are stacked to increase the amount of vibration of the eccentric rotor. In one embodiment, the weight is of a material high in specific gravity, such as tungsten, aligned with the outer circumference of the board, to maximize the amount of vibration. In one embodiment, the weight is fan-shaped with a central angle of 180° or less.

In one embodiment, the attachment member can easily be formed through the injection molding of low-density plastic resin. In one embodiment, the thickness of the attachment member is equal to the thickness of the weight, so that the volume of the rotor may be reduced.

Still another aspect of the invention provides a vibration motor comprising: the above-described eccentric rotor, a shaft inserted through the insertion hole of the board, a housing that fixes both ends of the shaft, a magnet which is attached to the housing and has at least two poles, and a pair of brushes formed within the central cavity of the magnet and connected to the commutators. In one embodiment, the vibration motor can not only reduce the volume of the eccentric rotor, but also increase the amount of vibration. In another embodiment, as no wound coils are used, there is an additional effect of reduced production time and cost.

In one embodiment, the shaft is connected to the eccentric rotor by way of a bearing, in order to reduce friction between the eccentric rotor and the shaft, and provide a smoother rotation of the rotor. In one embodiment, the bottom of the eccentric rotor is supported by a washer inserted onto the shaft, to prevent vertical displacement of the eccentric rotor when the vibration motor receives an impact, e.g., from the portable device being dropped. In one embodiment, the patterned coils are arranged at about 60° intervals, and the magnet is permanently magnetized by 4 alternating N/S poles, to maximize the amount of vibration of the eccentric rotor.

### BRIEF DESCRIPTION OF THE DRAWINGS

FIG. 1 is a sectional view of a conventional vibration motor;

FIG. 2a is a perspective view illustrating the upper portion of the conventional eccentric rotor;

FIG. 2b is a perspective view illustrating the lower portion of the conventional eccentric rotor;

FIG. 3 is a sectional view illustrating a vibration motor according to an embodiment of the invention;

FIG. 4a is a perspective view illustrating the upper portion of an eccentric rotor according to an embodiment of the invention;

FIG. 4b is a perspective view illustrating the lower portion of the eccentric rotor according to an embodiment of the invention;

FIG. 5 is a plan view of patterned coil layers according to an embodiment of the invention;

FIG. 6 is a sectional view of the patterned coil layers according to an embodiment of the invention;

FIG. 7a is a perspective view illustrating the upper portion of an eccentric rotor according to another embodiment of the invention;

FIG. 7b is a perspective view illustrating the lower portion of the eccentric rotor according to another embodiment of the invention;

FIG. 8 is a sectional view of a vibration motor according to another embodiment of the invention;

FIG. 9 is a plan view of patterned coil layers according to an embodiment of the invention.

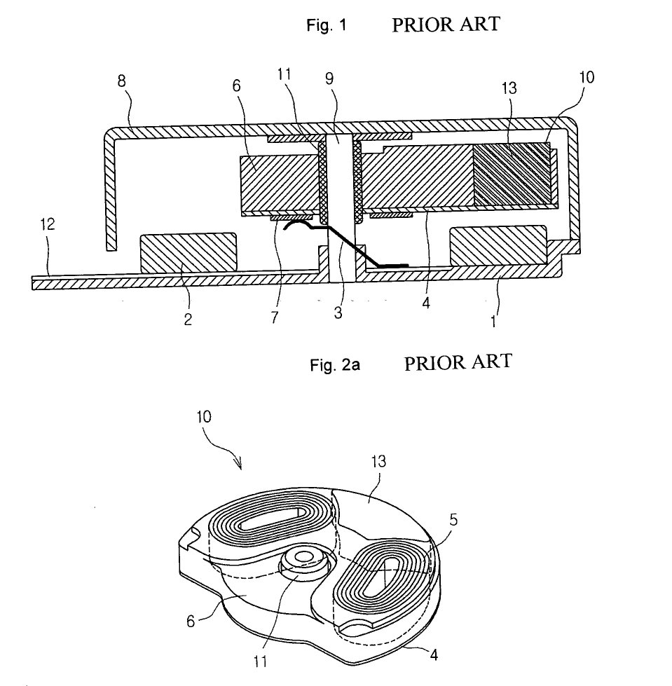

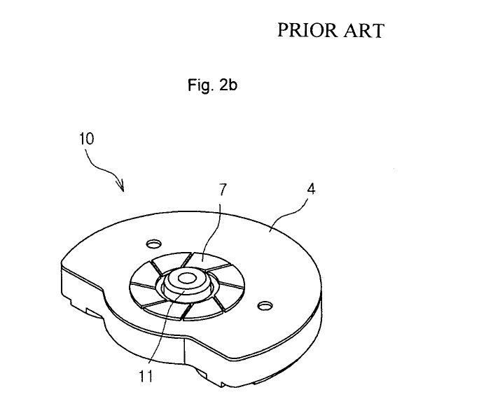

### DETAILED DESCRIPTION OF CERTAIN INVENTIVE EMBODIMENTS

Hereinafter, embodiments of the invention will be described in more detail with reference to the accompanying drawings.

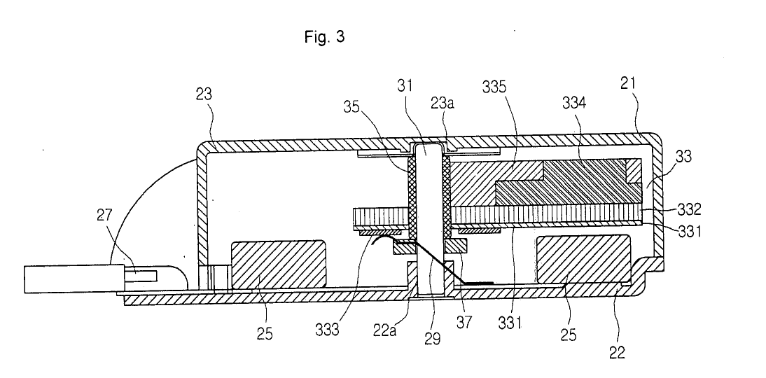

FIG. 3 is a sectional view illustrating a vibration motor according to an embodiment of the invention. In one embodiment, the vibration motor comprises: a housing 21 having a bracket 22 and case 23, a shaft 31 secured within the housing 21, an eccentric rotor 33 inserted onto the shaft 31 by way of a bearing 35, and a washer 37 inserted onto the shaft 31 which supports the bottom of the eccentric rotor 33. The motor also includes a donut-shaped magnet 25 attached to the bracket 22, a printed circuit board 27 positioned on the bracket 22, and brushes 29 which are in contact with the lower portion of the eccentric rotor 33 and which transfer current received from the printed circuit board 27 to the eccentric rotor 33.

The housing 21 includes the bracket 22 and case 23. The housing 21 contains the magnet 25, the printed circuit board 27, the brushes 29, the shaft 31, the eccentric rotor 33, the bearing 35, and the washer 37.

As seen in FIG. 3, a bracket groove 22a into which one end of the shaft 31 is inserted is formed in the center of the bracket 22. The lower end of the shaft 31 is inserted into and fixed to the bracket groove 22a. The printed circuit board 27 is positioned on the upper portion of the bracket 22. The donut-shaped magnet 25 is positioned on the printed circuit board 27. The bracket 22 is connected to the case 23.

The case groove 23a into which the other end of the shaft 31 is inserted is formed in the center of the case 23. The upper end of the shaft 31 is inserted into and fastened to the case groove 23a. The lower portion of the case 23 is separated from an attachment member 335 of the eccentric rotor 33 at a constant distance.

The magnet 25 is positioned on the upper portion of the bracket 22. In one embodiment, the magnet 25 is donut-shaped, and within the inner cavity are positioned the brushes 29 and the shaft 31. The magnet 25 has at least two poles. In one embodiment, to increase the electromagnetic force of the eccentric rotor 33, the magnet 25 has four or more poles. The magnet 25 has alternating N poles and S poles of equal magnitude. The magnet 25 generates a magnetic field, which interacts with the electrical field created by the patterned coils 332 of the eccentric rotor 33. Such an interaction generates an electromagnetic force according to Fleming's Left Hand Rule, and rotates the eccentric rotor 33.

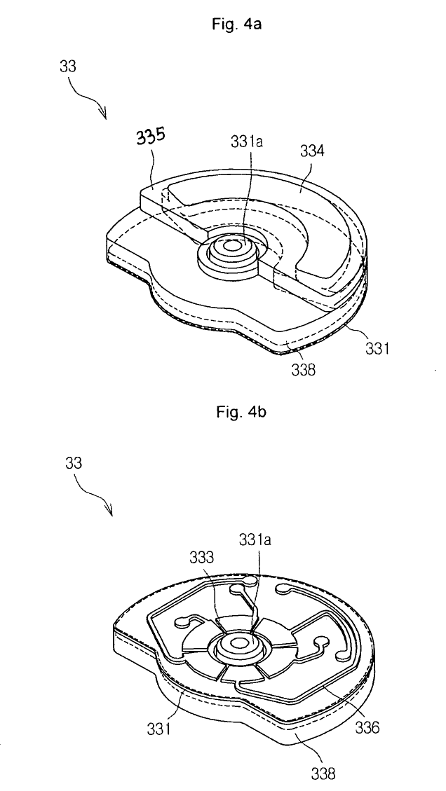

Both ends of the shaft 31 are pressed into and fixed to the case groove 23a and bracket groove 22a, to support the eccentric rotor 33 while the eccentric rotor 33 rotates. The bearing 35, which smoothens the rotation of the eccentric rotor 33, is inserted and fixed onto a designated position of the shaft 31. The bearing 31 is inserted onto the shaft 31 and supported by the washer 37, and is connected to the eccentric rotor 33 by means of the attachment member 335 placed in an insertion hole 331a (see FIG. 4a or 4b) of the eccentric rotor 33.

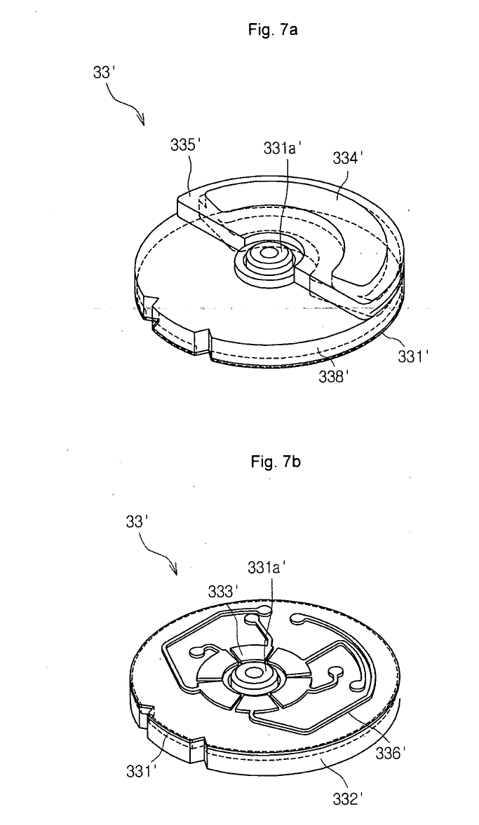

A pair of the brushes 29 (only one brush shown on FIG. 3) are positioned within the magnet 25, each of which has one end electrically connected to the printed circuit board 27, and the other end in contact with the commutators (333 in FIG. 4b or 333′ in FIG. 7b) on the other side of the eccentric rotor 33. The brushes 29 transfer the current received from the printed circuit board 27 to the commutators 333.

The washer 37 is inserted and fastened onto the shaft 31. The washer 37 is in contact with the lower portion of the eccentric rotor 33 or the bearing 35, and supports the eccentric rotor 33. Thus, in one embodiment, even when there is an external impact on the vibration motor, the eccentric rotor 33 is not displaced from its original position, because the eccentric rotor 33 is supported by the washer 37.

FIGS. 4a and 4b are perspective views illustrating the upper and lower portions of the eccentric rotor 33 according to an embodiment of the invention.

As seen in FIGS. 3 to 4b, the eccentric rotor 33 comprises: i) the board 331, ii) a plurality of patterned coil layers 338 formed on the upper portion of the board 331, iii) the weight 334 formed on the patterned coil layers 338, iv) the attachment member 335, and v) the commutators 333. The insertion hole 331a into which the shaft 31 is inserted is formed on the board 331. The attachment member 335 fastens the weight 334 to the patterned coil layers 338. The commutators 333 are typically shaped as flat plates formed around the insertion hole 331a along the circumference on the other side of the board 331.

The shaft 31 is inserted through the board 331 on which the patterned coil layers 338 are formed. The board 331 supports the weight 334. In the center of the board 331, the insertion hole 331a is perforated, through which the shaft 31 is inserted. In one embodiment, the board 331 may be of any shape, as long as the shaft 31 is fastened and can create eccentricity when rotated. For example, the board 331 may have a circular or semicircular cross section. That is, after the board 331 is formed to have a semicircular cross section, eccentricity may be created by forming the patterned coil layers 338 to correspond to the shape of the board 31. Also, to increase the magnitude of the electrical field that interacts with the magnetic field, the board 31 may have a circular shape, as shown in FIGS. 7a and 7b.

In the present embodiment, the board 31 is formed to have a semicircular shape, and the patterned coil layers 338 are formed correspondingly.

The commutators 333, as shown in FIG. 4b, are wiring boards with the shape of a flat plate arranged around the insertion hole 331a on the other side of the board 331 at constant intervals along the circumference. Each commutator 333 is connected to a patterned coil 332 (see FIG. 3), and provides current to the patterned coil 332. In one embodiment, the number of the commutators 333 is an integer multiple of the number of patterned coils 332 in a single layer. For example, if the number of patterned coils is six in one patterned coil layer, the commutators 333 may be formed to be six or twelve.

Each of the commutators 333 is electrically connected to the patterned coil 332 by an electrically conductive pattern 336, and the commutators 333 are in contact with the brushes 29. Therefore, the current input through the brushes 29 flows through the commutators 333 and is provided to the patterned coils 332.

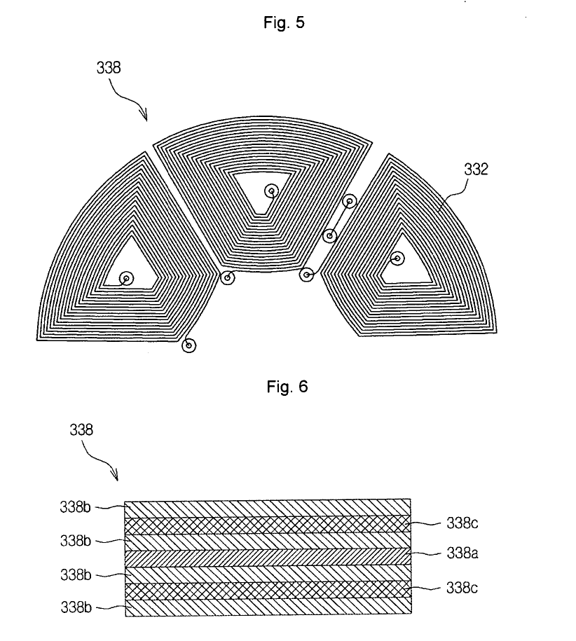

The patterned coil layers 338 are pattern shaped coils formed by, for example, photolithography or thick film processes. In one embodiment, each patterned coil layer 338 has several patterned coils 332 formed with constant intervals, as shown in FIG. 5.

FIG. 6 is a sectional view of the patterned coil layers 338 according to an embodiment of the invention. As shown in FIG. 6, the patterned coil layers 338 comprise: a base 338a which acts as the foundation material, copper foils 338b which are stacked on either side of the base 338a, and the insulation layers 338c which are stacked on the copper foils 338b.

The base 338a is formed by, for example, epoxy resin, etc., and supports the copper foils 338b. The patterned coils 332 are formed on the copper foils 338b by, for example, etching or corrosion. Each copper foil 338b is insulated by insulation layers 338c.

In one embodiment, a multi-layered structure for the patterned coil layers 338 may be formed by repeatedly stacking the copper foils 338b and insulation layers 338c. In another embodiment, the patterned coil layers 338 may be formed by successively stacking patterned coil layers and insulation layers on one side of the base 338a.

In one embodiment, since a patterned coil layer 338 is very thin, about 0.02 mm-about 0.05 mm (and a width of about 0.03 mm-about 0.07 mm), there is an advantage that stacking several layers do not significantly increase the volume. In one embodiment, the patterned coil layers 338 are formed by six or more layers to increase the electrical field generated by the patterned coils 338.

The patterned coils 332 generate an electrical field based on the received current and together with the magnet 25 create an electromagnetic force. In one embodiment, the patterned coils 332 are arranged in correspondence with the shape of the board 331. In one embodiment, the number of layers of the patterned coil layers 338 is determined according to the desired magnitude of vibration and the cross sectional size of the patterned coils.

As shown in FIG. 5, in one embodiment, each patterned coil layer 338 can be formed by a plurality of patterned coils 332, to increase the torque applied on the eccentric rotor 33.

The patterned coils 332 are formed by a layer with a much smaller volume compared to conventional wound coils, so that the size (and volume) of the weight 334 may be made bigger, as shown in FIG. 4a. Also, the patterned coils 332 may use conventional manufacturing equipment for printed circuit boards, so that there is the advantage of reduced production time and cost compared to conventional wound coils.

In one embodiment, the weight 334 is fan-shaped, and is positioned on the upper part of the patterned coils 332. The weight 334 plays the role of increasing the eccentricity of the eccentric rotor 33. That is, to the eccentricity created by the board 331 with its semicircular shape about the central insertion hole 331a and by the patterned coil layers 338 formed in correspondence to the shape of the board 331, the weight 334 is added, causing further eccentricity.

In one embodiment, the weight 334 is formed by a metal high in specific gravity such as tungsten, but is not limited to this type of material. Since the size of the weight 334 is not limited by the wound coils in contrast to conventional rotors, its size may be larger, thus providing an increased degree of eccentricity.

The eccentricity is the greatest when the central angle of the weight 334 is 180°, but the central angle may be changed as necessary. However, if the central angle of the weight 334 is more than 180°, the amount of mass for the angle above 180° offsets the eccentricity. In one embodiment of the invention, the central angle is 180° or less. In one embodiment, the weight 334 is aligned with the outermost perimeter of the board 331, that is, the outer circumference of the board 331, to further increase the eccentricity. The weight 334 is attached to the patterned coils 332 by the attachment member 335.

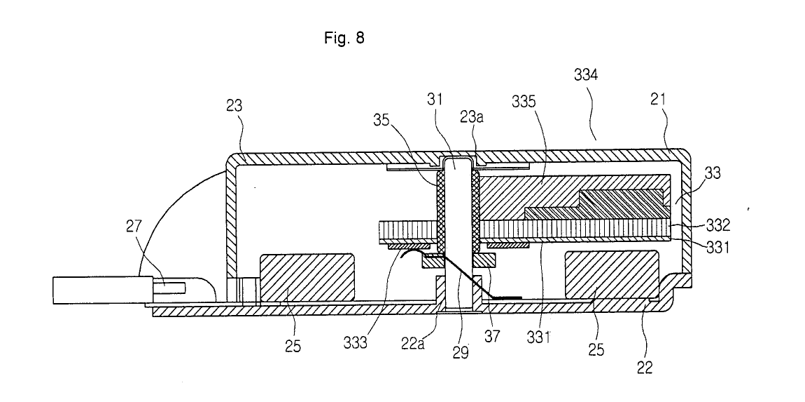

In one embodiment, the attachment member 335 is an injection-molded product of plastic resin. It is injected onto the patterned coils 332 and attaches the weight 334 to the patterned coils 332. In addition, the attachment member 335 is also inserted into the insertion hole 331a of the board 331, and connects the bearing 35 to the board 331. In one embodiment, the height of the attachment member 335 may be made equal to the thickness of the weight 334 to reduce the thickness of the eccentric rotor 33. In another embodiment, as shown in FIG. 8, the height may be made greater than the thickness of the weight 334 to further increase the eccentricity and more tightly secure the weight 334.

FIGS. 7a and 7b are perspective views illustrating the upper and lower portions of an eccentric rotor according to another embodiment of the invention. The eccentric rotor 33′ shown in FIGS. 7a and 7b is the same as the eccentric rotor 33 shown in FIGS. 4a and 4b except for the structure of the board 331′ and patterned coil layers 338′. Hereinafter, only the board 331′ and patterned coil layers 338′ are described. In this embodiment, the board 331′ has a circular cross section with the insertion hole 331a′ as its center. By giving the board 331′ a circular shape, the patterned coil layers 338′ formed on the board 331′ may also have a circular shape, by which the torque of the eccentric rotor 33′ may be made greater. In one embodiment, since the board 331′ has no eccentricity about the insertion hole 331a′, a weight 334′ is added to create eccentricity.

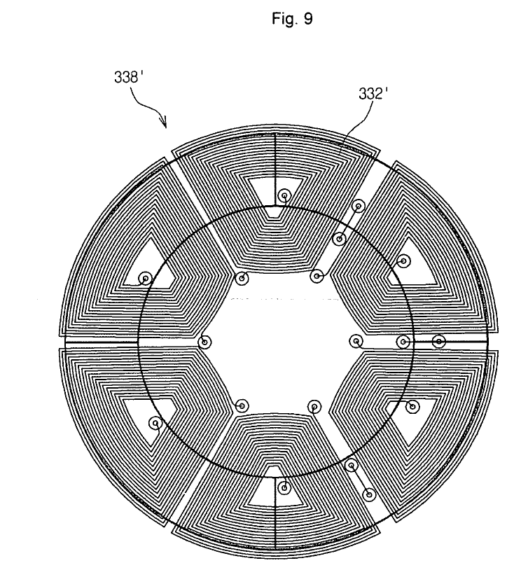

The patterned coil layers 338′ are arranged on the circular board 331′ at equal intervals. As shown in FIG. 9, six patterned coils are arranged at 60° intervals on a single patterned coil layer 338′. In one embodiment, the magnet 25 has four alternating poles to increase the electromagnetic force. In another embodiment, the patterned coils 332′ arranged on a layer may be changed as necessary. Also, each patterned coil 332′ is electrically connected to the commutators 333′. In one embodiment, the number of commutators 333′ is an integer multiple of the number of patterned coils 332′.

One embodiment of the invention has the effect of providing an eccentric rotor and a vibration motor having the eccentric rotor with a smaller volume and higher vibration performance. Another embodiment of the invention has the effect of reducing the cost and time of the rotor and motor manufacture.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. An eccentric rotor, comprising:
a board having an insertion hole;
a plurality of patterned coil layers formed on an upper portion of the board, wherein each patterned coil layer has multiple patterned coils, and wherein the plurality of patterned coil layers are stacked on one another; and
a plurality of commutators formed on a lower portion of the board, wherein the plurality of commutators are electrically connected to the patterned coils and are formed in integer multiples of the patterned coils, wherein the board rotates eccentrically with respect to the insertion hole.

2. The eccentric rotor according to claim 1, further comprising:
a weight formed on the plurality of patterned coil layers; and an attachment member configured to secure the weight on the plurality of patterned coil layers.

3. An eccentric rotor, comprising:
a circular board having an insertion hole;
a plurality of patterned coil layers formed into a stack on an upper portion of the board, each coil layer having multiple patterned coils;
a plurality of commutators formed on a lower portion of the board, wherein the plurality of commutators are electrically connected to the patterned coils and are formed in integer multiples of the patterned coils;
a weight formed on the patterned coil layers; and
an attachment member configured to fix the weight to the patterned coil layers.

4. The eccentric rotor according to claim 1, wherein the patterned coil layers are stacked successively on both sides of a base, with insulation layers in-between the patterned coil layers.

5. The eccentric rotor according to claim 1, wherein the patterned coils are arranged radially at constant intervals.

6. The eccentric rotor according to claim 1, wherein the patterned coil layers are stacked in six or more layers.

7. The eccentric rotor according to claim 2, wherein the weight is formed of tungsten.

8. The eccentric rotor according to claim 2, wherein the weight is aligned with the outer circumference of the board.

9. The eccentric rotor according to claim 2, wherein the weight is fan-shaped with a central angle of 180° or less.

10. The eccentric rotor according to claim 2, wherein the thickness of the attachment member is equal to that of the weight.

11. The eccentric rotor according to claim 2, wherein the attachment member is of a plastic resin formed by injection molding.

12. A vibration motor, comprising:
a board having an insertion hole;
an eccentric rotor including a plurality of patterned coil layers formed in a stack on an upper portion of the board, wherein each patterned coil layer has multiple patterned coils;
a plurality of commutators formed on a lower portion of the board;
a shaft inserted through the insertion hole of the board;
a housing that secures both ends of the shaft;
a magnet which is attached to the housing and has at least two poles; and
a pair of brushes which contact the commutators.

13. The vibration motor according to claim 12, wherein the shaft is inserted to the insertion hole by way of a bearing.

14. The vibration motor according to claim 12, wherein the eccentric rotor is supported by a washer inserted onto the shaft.

15. The vibration motor according to claim 12, wherein the patterned coils are arranged at about 60° intervals, and the magnet is magnetized by four alternating N/S poles.

16. An eccentric rotor for use with a vibration motor, comprising:
at least one patterned coil layer configured to rotate the rotor by electromagnetic force generated by carrying a current near a magnet.

17. The eccentric rotor of claim 16, further comprising a weight formed on the at least one patterned coil layer.

18. The eccentric rotor of claim 16, wherein the at least one coil layer includes a plurality of patterned coil layers.

19. The eccentric rotor of claim 18, wherein each coil layer includes a plurality of patterned coils.

20. The eccentric rotor of claim 19, wherein the patterned coils are arranged radially at constant intervals.

21. An eccentric rotor, comprising:
a plurality of patterned coil layers; and
a weight formed on the plurality of patterned coil layers.

22. The eccentric rotor of claim 21, wherein the plurality of patterned coil layers include:
a base layer; and
first and second coil layers formed on both sides of the base layer, respectively.

23. The eccentric rotor of claim 22, wherein the plurality of patterned coil layers further include:
a pair of insulation layers formed on the first and second coil layers, respectively; and
third and fourth coil layers formed on the pair of insulation layers, respectively.

24. The eccentric rotor of claim 21, wherein the patterned coil layers are stacked in six or more layers.

25. A vibration motor, comprising:
a magnet; and
an eccentric rotor including a plurality of patterned coil layers, wherein the plurality of patterned coil layers are configured to rotate the rotor by an electromagnetic force associated with carrying a current near the magnet.

26. The vibration motor of claim 25, wherein each coil layer includes a plurality of patterned coils.

27. The vibration motor of claim 26, wherein the plurality of patterned coils are arranged at about 60° intervals.

28. An eccentric rotor, comprising:
means for generating an electromagnetic field that forms a substantially flat substrate; and
means for providing eccentricity of the rotor, wherein the providing means is formed on the generating means.

29. The eccentric rotor of claim 28, wherein the generating means includes at least one patterned coil layer.

30. The eccentric rotor of claim 28, wherein the providing means includes a weight.
